(19) United States
(12) Patent Application Publication
(10) Pub. No.: US 2018/0157485 A1
(43) Pub. Date: Jun. 7, 2018

(54) SOFTWARE MANAGEMENT INTEGRATION IN A PRODUCT MANAGEMENT SYSTEM

(71) Applicant: SAP SE, Walldorf (DE)

(72) Inventor: Pascal Kugler, Walldorf (DE)

(21) Appl. No.: 15/368,488

(22) Filed: Dec. 2, 2016

(51) Int. Cl. G06F 9/44

(52) U.S. Cl. CPC G06F 8/71

(57) ABSTRACT

A system and method for integrating software development into product development management and enterprise resource planning of a product are disclosed. A system includes a source code management system having a code repository for storing binary versions of software to control the product, and a continuous integration platform to manage integration and build activities of each component of the software. The build activities include compiling, linking, testing and publishing of each component of the software. The build activities are triggered by a new commit or in a multi-stage environment by a successful build of a dependent software component, the continuous integration platform being connected with a product development management and enterprise resource planning platform to integrate each component of the software with other components of the product.

### TECHNICAL FIELD

The subject matter described herein relates to software management integration to enable businesses to represent, control and manage the whole software lifecycle within one central system.

### BACKGROUND

Product manufacturing companies are changing and evolving in many ways, but in particular with respect to manufacturing products that include not only hardware and electronics, but the software used to control or operate the product. More and more, the software of the product and its related features will determine a product's success or failure in the market. Engineering and manufacturing companies which in the past had dealt only or mainly with mechanical and electrical parts of a product are facing new challenges to adapt and integrate software into their product development and product lifecycle processes.

An enterprise such as a product manufacturing company needs to be able to know which software version is compatible with a certain module, which version is available and should get installed or “flashed” to the product on the shop floor, and whether the software of individual components will work together on the hardware as designed. To know these answers, the business has to manage the software in an enterprise resource planning (ERP) system to get a harmonized view on all components of the product, regardless of whether it is a mechanical, electronic or software part. Accordingly, the software should be handled as merely a part of the overall product.

Consider the example of an automobile manufacturer. An automobile includes a number of subsystems called Electronic Control Units (ECUs). Each ECU is designed for a dedicated functionality: e.g. Airbag-ECU, Anti-lock Braking System (ABS)-ECU, electronic stability program (ESP)-ECU, etc. Every ECU includes software to control related electronics and/or hardware of the different subsystems. The management of the different versions and releases is in itself a complex and error-prone process.

However, there is still another layer of complexity: integration. Successful integration of all of the different subsystem software is a major determinant as to whether or not the product will work properly. All subsystems have to work properly together to ensure the safety and proper operation of the automobile, such the ESP-ECU working together with the ABS-ECU, for example. Further, before a final system test, both systems need to compile together and still perform as designed. This is especially a challenge if the modules get developed by different teams or are delivered by different suppliers.

### SUMMARY

This document describes a system and method for continuous integration of software as a part in a product development management (PDM)/enterprise resource management (ERP) system.

In one aspect, a system for integrating software development into product development management and enterprise resource planning of a product is disclosed. The system includes a source code management system having a code repository for storing binary versions of software to control the product. The system further includes a continuous integration platform to manage integration and build activities of each component of the software. The build activities include compiling, linking, testing and publishing of each component of the software, the build activities being triggered by a new commit or in a multi-stage environment by a successful build of a dependent software component. The continuous integration platform is connected with a product development management and enterprise resource planning platform to integrate each component of the software with other components of the product.

In another aspect, a method for integrating software development into product development management and enterprise resource planning of a product is disclosed. The method includes storing binary versions of software to control the product in a source code management system having a code repository. The method further includes managing integration and build activities of each component of the software in a continuous integration platform connected with the code repository of the source code management system. The build activities including compiling, linking, testing and publishing of each component of the software, the build activities being triggered by a new commit or in a multi-stage environment by a successful build of a dependent software component.

In yet another aspect, a non-transitory computer program product is disclosed. The computer program product stores instructions that, when executed by at least one programmable processor, cause the at least one programmable processor to store binary versions of software to control a product in a source code management system having a code repository, manage integration and build activities of each component of the software in a continuous integration platform connected with the code repository of the source code management system. The build activities are triggered by a new commit or in a multi-stage environment by a successful build of a dependent software component. The instructions further cause the at least one programmable processor to compile, link, test and publish each component of the with a product development management and enterprise resource planning platform to integrate each component of the software with other components of the product.

Implementations of the current subject matter can include, but are not limited to, systems and methods consistent including one or more features are described as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a system and method to integrate software development as part of a PDM/ERP system, using a software control center (CSC).

FIG. 2 illustrates a software control center in accordance with implementations disclosed herein.

FIG. 3 is a flowchart of a method for integrating software development in a PDM/ERP system.

When practical, similar reference numbers denote similar structures, features, or elements.

### DETAILED DESCRIPTION

This document describes systems and methods to integrate software as a part in a product development management (PDM)/enterprise resource management (ERP) system. In order to track the compatibility and usage of software for integration with a product, i.e. to observe the software together with the mechanical and electronic parts of the product, the software versions, if developed outside of the PDM/ERP system, need to be transferred to the PDM/ERP system. In other words, the binaries, i.e. code, of the software can be (and usually are) built outside of an enterprise's PDM/ERP system, but at least the software components and the information about the available versions should get maintained in the PDM/ERP system to make versions available to the enterprise.

The product development is then able to design specific software components to the different Bill of Materials (BOMs) and keep track of the usage of a specific software version throughout the whole supply chain and BOM lifecycle (as-designed, as-planned, as-built, as-installed). In addition, a compatibility matrix between mechanical, electronic and software parts is built so that an enterprise can have all information about a product in one system. This “master data” can be used to avoid the design of incompatible components, as well as enabling service engineers in the field to flash a proper software version on a machine on a customer site, such as a filling machine at a bottling plant, for example, which at the end will save time and money.

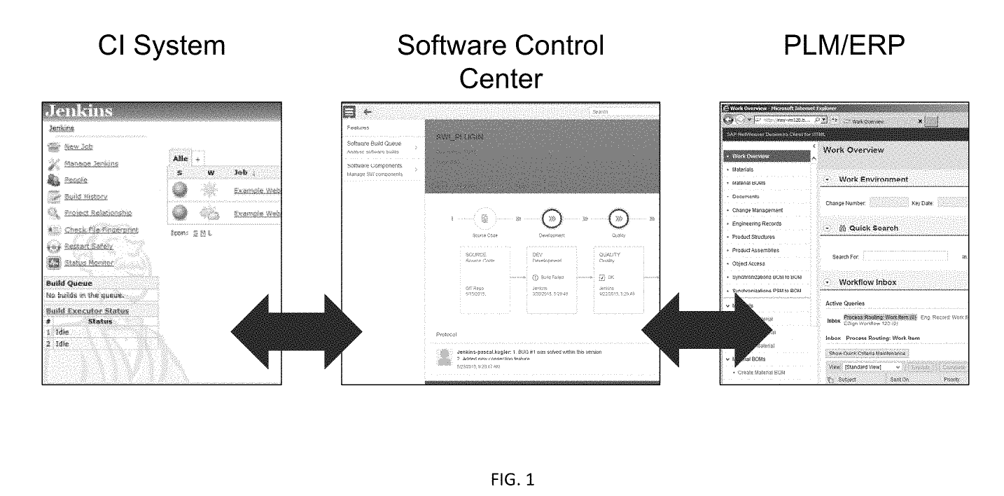

In preferred implementations, as shown in FIG. 1, a Source Code Management (SCM) system is used as a code repository. Every software component has a dedicated source code repository to manage different versions and branches, and to maintain a history of commits for the software component.

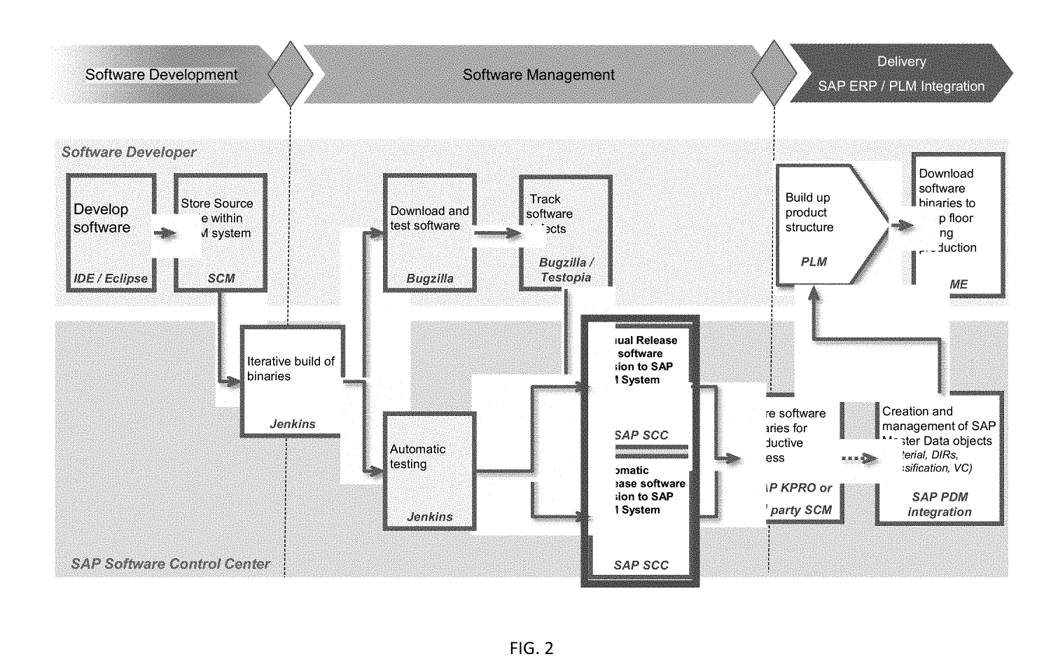

Further, a Continuous Integration (CI) platform is used, as illustrated in FIG. 2. The CI platform takes care of the integration and build activities of each software component. This includes not only basic compiling and linking steps, but also testing and publishing activities. A CI build can be triggered by a new commit or in a multi-stage environment by a successful CI build of a dependent software component, i.e., in order to ensure that a new version of software component A integrates with the latest version of a software component B. These activities and related tests (either on real hardware or a virtualization environment) can be automated. This reduces the chance of a manual error and speeds up the delivery process, and to ensure the quality, consistency and reliability of the software and reduce the time to delivery of a new software version.

In some implementations, a binary repository is used. If a software component version passes the production gate, the CI platform will generate the final tested, released and signed binaries, which can get flashed on the final product. The binaries and the related documentation can be saved to make them accessible for production and service organization. This could be a code versioning system (CVS) or a dedicated tool or third party repository for binary code.

Finally, software is integrated as a part in a PDM/ERP system. In order to track the compatibility and usage of the software, i.e. to see it together with the mechanical and electronic parts, the software versions need to be transferred to the enterprise's ERP/PDM system. The binaries need not necessarily be moved, but at least the software components and the information about the available versions should get maintained in the ERP/PDM system to make them available to the business. The product development team would then be able to design the specific software components to the different BOMs and keep track of the usage of a specific software version throughout the whole supply chain and BOM lifecycle (as-designed, as-planned, as-built, as-installed). The ERP/PDM system can build up a compatibility matrix between the mechanical, electronic and software parts to provide all information in one system, and to avoid the design of incompatible components.

While manual creation of such master data is not manageable, especially in the area of software development where multiple commits per day are common, the systems and methods disclosed herein provide a solution to overcome this issue by integrating the software development process with a software control center (SCC). The SCC integrates new software versions into the SAP ERP/PLM system by creating master data based on CI builds and the provided metadata. Keeping track of the origin of the software version via the provided metadata of the connected CI platform is a key factor to be able to manage the whole software lifecycle.

The system and method described herein integrates a continuous integration and automation platform. Through this integration it is possible to connect to all common Source Code Management (SCM) systems. Additional CI platform integrations can be added. The system and method allows users to create a representation of each system within the software development landscape. All components can be monitored from a centralized PLM and can provide a quick access to the native system itself. The system and method can be integrated with the most commonly used bug tracking systems. Based on this integration, the release readiness of a software version can be determined. The solution introduces only one new object: the software component. This object can be linked to a SAP material master. All other objects get represented by an ordinary SAP ERP object like DIRs and classification. So there is no restriction to use the integrated data in subsequent logistic processes.

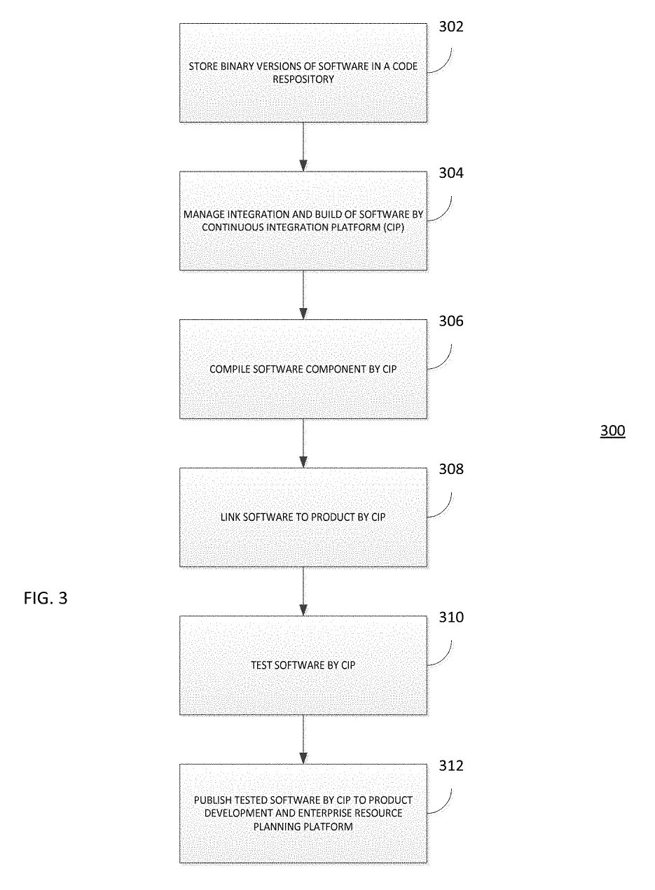

FIG. 3 is a flowchart 300 of a method for integrating software development in a PDM/ERP system. At 302, binary versions of software or software components are stored in a code repository. The code repository can be associated with a source code management system. At 304, the integration and build of the software, by a continuous integration platform (CIP), is managed and executed automatically. At 306, the software component(s) are compiled by the CIP, and at 308, the software component(s) are linked by the CIP to an associated product.

At 310, the software component(s) are tested by the CIP for integration by the product, including any electrical or mechanical components of the product. At 312, the tested software, if approved, is published by the CIP to a product development and/or enterprise resource planning platform associated with the product. This enables the full integration of the latest software component with a developed product.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT), a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A system for integrating software development into product development management and enterprise resource planning of a product, the system comprising:
a source code management system having a code repository for storing binary versions of software to control the product; and
a continuous integration platform to manage integration and build activities of each component of the software, the build activities including compiling, linking, testing and publishing of each component of the software, the build activities being triggered by a new commit or in a multi-stage environment by a successful build of a dependent software component, the continuous integration platform being connected with a product development management and enterprise resource planning platform to integrate each component of the software with other components of the product.

2. The system in accordance with claim 1, wherein the source code management system and code repository further stores different versions and branches of the software.

3. The system in accordance with claim 2, wherein the source code management system and code repository further maintains a history of commits for the software.

4. The system in accordance with claim 2, wherein the source code management system further stores electronic documentation related to the binary versions of software.

5. The system in accordance with claim 1, further comprising a compatibility matrix generated by the product development management and enterprise resource planning platform based on information from the continuous integration platform, the compatibility matrix representing a compatibility between each component of the software and mechanical and/or electrical components of the product.

6. The system in accordance with claim 1, wherein the integration and build activities of each component of the software by the continuous integration platform generate a final binary set of the software for being accessed by the product development management and enterprise resource planning.

7. A method for integrating software development into product development management and enterprise resource planning of a product, the method comprising:
storing binary versions of software to control the product in a source code management system having a code repository; and
managing integration and build activities of each component of the software in a continuous integration platform connected with the code repository of the source code management system, the build activities including compiling, linking, testing and publishing of each component of the software, the build activities being triggered by a new commit or in a multi-stage environment by a successful build of a dependent software component.

8. The method in accordance with claim 7, further comprising connecting the continuous integration platform with a product development management and enterprise resource planning platform to integrate each component of the software with other components of the product.

9. The method in accordance with claim 7, wherein the source code management system and code repository further stores different versions and branches of the software.

10. The method in accordance with claim 9, wherein the source code management system and code repository further maintains a history of commits for the software.

11. The method in accordance with claim 10, wherein the source code management system further stores electronic documentation related to the binary versions of software.

12. The method in accordance with claim 7, further comprising generating, by the product development management and enterprise resource planning platform based on information from the continuous integration platform, a compatibility matrix representing a compatibility between each component of the software and mechanical and/or electrical components of the product.

13. A non-transitory computer program product storing instructions that, when executed by at least one programmable processor, cause the at least one programmable processor to perform operations comprising
store binary versions of software in a source code management system having a code repository, the software to control a product;
manage integration and build activities of each component of the software in a continuous integration platform connected with the code repository of the source code management system, the build activities being triggered by a new commit or in a multi-stage environment by a successful build of a dependent software component; and
compile, link, test and publish each component of the with a product development management and enterprise resource planning platform to integrate each component of the software with other components of the product.

14. The computer program product in accordance with claim 13, wherein the instructions further cause the at least one programmable processor to connect the continuous integration platform with a product development management and enterprise resource planning platform to integrate each component of the software with other components of the product.

15. The computer program product in accordance with claim 14, wherein the instructions further cause the at least one programmable processor to store different versions and branches of the software.

16. The computer program product in accordance with claim 15, wherein the instructions further cause the at least one programmable processor to maintain a history of commits for the software.

17. The computer program product in accordance with claim 13, wherein the instructions further cause the at least one programmable processor to store electronic documentation related to the binary versions of software.

18. The computer program product in accordance with claim 13, wherein the instructions further cause the at least one programmable processor to generate a compatibility matrix representing a compatibility between each component of the software and mechanical and/or electrical components of the product.
